(19) United States
(12) Patent Application Publication
(10) Pub. No.: US 2005/0174305 A1
(43) Pub. Date: Aug. 11, 2005

(54) Plasma display and driving method thereof

(76) Inventors: Su-Yong Chae, Suwon-si (KR); Joon-Yeon Kim, Suwon-si (KR)

Correspondence Address: CHRISTIE, PARKER & HALE, LLP, PO BOX 7068, PASADENA, CA, 91109-7068, US

(21) Appl. No.: 11/054,119

(22) Filed: Feb. 8, 2005

(30) Foreign Application Priority Data
Feb. 10, 2004 (KR) 10-2004-0008691

(51) Int. Cl. G09G 3/28

(52) U.S. Cl. 345/60

(57) ABSTRACT

In a plasma display and method thereof, the display includes an M electrode formed between an X electrode and a Y electrode in which a sustain discharge pulse voltage is applied. In addition, a reset waveform and a scan pulse voltage are applied to the M electrode. As such, the M electrode is biased at a first voltage in a first sustain discharge pulse period of a sustain discharge period, and the M electrode is floated in a period after the first sustain discharge pulse period of the sustain discharge period. A sustain discharge voltage pulse is alternately applied to the X electrode and the Y electrode in the sustain discharge period.

### CROSS REFERENCE TO RELATED APPLICATION

This application claims priority to and the benefit of Korean Patent Application No. 10-2004-0008691, filed on Feb. 10, 2004, in the Korean Intellectual Property Office, the entire content of which is incorporated herein by reference.

### BACKGROUND OF THE INVENTION

1. Field of the Invention

The present invention relates to a plasma display and a driving method thereof.

2. Discussion of the Related Art

Various flat panel displays such as the liquid crystal display (LCD), the field emission display (FED), and the plasma display panel (PDP) have been developed. The plasma display panel has higher resolution, a higher rate of emission efficiency, and a wider view angle in comparison with other flat panel displays. Accordingly, the PDP is in the spotlight as a display that can be substituted for the conventional cathode ray tube (CRT), especially in the large-sized displays of greater than forty inches.

A PDP is a flat panel display for showing characters or images using plasma generated by gas discharge, and includes more than hundreds of thousands to millions of pixels arranged in a matrix format, in which the number of pixels are determined by the size of the PDP. A PDP can be categorized as a direct current (DC) PDP or an alternating current (AC) PDP according to an applied driving voltage waveforms and the structures of the discharge cells of the PDP.

Electrodes of the DC PDP are exposed in a discharge space and the current flows in the discharge space when a voltage is applied, and therefore the DC PDP is problematic in that it requires a resistor for current limitation. On the other hand, electrodes of the AC PDP are covered with a dielectric layer so the current is limited because of natural formation of capacitance components, and the electrodes are protected from ion impulses in the case of discharging. As such, the AC plasma PDP usually has a longer lifespan than that of the DC PDP.

FIG. 1 shows a partial perspective view of the AC PDP, and FIG. 2 shows a sectional view of the PDP shown in FIG. 1.

With reference to FIG. 1 and FIG. 2, Y electrodes 4 and X electrodes 3 in pairs are formed in parallel on a first glass substrate 11, and are covered with a dielectric layer 14 and a protection film 15. The X electrode and the Y electrode are formed of transparent conductive materials. Bus electrodes 6 formed of metal materials are respectively formed on the X electrodes 3 and the Y electrodes 4.

A plurality of address electrodes 5 are established on a second glass substrate 12, and the address electrodes 5 are covered with a dialectic layer 14′. Barrier ribs 17 are formed parallel with the address electrodes 5 on the dialectic layer 14′ between the address electrodes 5, and phosphors 18 are formed on the surface of the dialectic layer 14′ and between the barrier ribs 17. The first glass substrate 11 and the second glass substrate 12 are provided to face each other with discharge spaces 19 between the glass substrates 11 and 12 so that the Y electrodes 4 and the X electrodes 3 may respectively cross the address electrodes 5. A discharge space 19 between the address electrode 5 and a crossing part of a pair of the Y electrode 4 and the X electrode 3 form a schematically indicated discharge cell 20.

FIG. 3 shows an electrode arrangement of the conventional PDP.

As shown in FIG. 3, the electrodes of the PDP have an m×n matrix format. The m address electrodes A₁ to Aₘ are arranged in the column direction, and n Y electrodes Y₁ to Yₙ and n X electrodes X₁ to Xₙ are alternately arranged in the row direction. A discharge cell 20 shown in FIG. 3 substantially corresponds to the discharge cell 20 shown in FIG. 1.

FIG. 4 shows driving waveforms of the conventional PDP.

In the conventional PDP, one frame or field is divided into a plurality of subfields that are combined to express a gray scale. Each subfield has a reset period, an address period, and a sustain period according to a PDP driving method shown in FIG. 4.

In the reset period, wall charges of previous sustain-discharging are eliminated, and new wall charges are generated so as to stably perform the next address discharging.

In the address period, cells that are turned on and those that are turned off on the panel are selected, and the wall charges are accumulated on the cells that are turned on (i.e., addressed cells).

In the sustain period, discharge for substantially displaying images on the addressed cells is performed.

An operation of the PDP driving method in the reset period will be described in more detail. As shown in FIG. 4, the reset period has an erasing period (I), a Y ramp rising period (II), and a Y ramp falling period (III).

(1) Erasing Period (I)

In the erasing period, a falling ramp gradually falling from a sustain-discharge voltage Vs to a ground potential (or 0V) is applied to the Y electrode while the X electrode is biased at a predetermined potential Vbias, and wall charges formed in a previous sustain period are eliminated.

(2) Y Ramp Rising Period (II)

A ramp voltage gradually rising from a voltage of Vs to a voltage of Vset is applied to the Y electrode while the address electrode (not shown) and the X electrode are maintained at 0V in the Y ramp rising period. Weak reset discharges are respectively generated from the Y electrode to the address electrode and the X electrode in the discharge cells while the ramp reset waveform is rising. Accordingly, (−) wall charges are accumulated on the Y electrode, and (+) charges are concurrently accumulated on the address electrode and the X electrode.

(3) Y Ramp Falling Period (III)

A ramp voltage gradually falling from the voltage of Vs to a ground voltage (or 0V) is applied to the Y electrode while the X electrode is maintained at a constant voltage of Vbias in the latter part of the reset period. Weak reset discharges are generated in the discharge cells while the ramp voltage is falling.

As such, in the conventional PDP, the sustain discharge operation is performed in the discharge cells after the address operation is performed from the first Y electrode to the last Y electrode. Accordingly, erroneous (or weak) discharges are problematically generated because not enough priming particles are generated in the discharge cell when the first sustain discharge pulse is applied after the address period.

Also, in the conventional PDP, the waveform applied to the Y electrode is different from the waveform applied to the X electrode (additional waveforms for reset and scan operations are applied to the Y electrode), and therefore a circuit for driving the Y electrode is different from a circuit for driving the X electrode. Accordingly, the impedance of the X electrode driving circuit is not matched to the impedance of the Y electrode driving circuit, the waveforms alternately applied to the X electrode and the Y electrode are distorted in the sustain period, and therefore the discharge quality is deteriorated.

### SUMMARY OF THE INVENTION

The present invention provides a plasma display for preventing erroneous discharges and a method thereof.

In one exemplary embodiment of the present invention, a method for driving a plasma display is provided. The plasma display includes a first electrode and a second electrode to which a sustain discharge voltage pulse is respectively applied, and a third electrode formed between the first electrode and the second electrode. In the method, in the sustain discharge period, a) the third electrode is biased at a first voltage while the sustain discharge voltage pulse is applied to the first electrode or the second electrode in a first part of the sustain discharge period, and b) the third electrode is floated while the sustain discharge voltage pulse is applied to the first electrode and/or the second electrode in a second part of the sustain discharge period.

In one exemplary embodiment of the present invention, a method for driving a plasma display is provided. The plasma display includes a first electrode and a second electrode to which a sustain discharge voltage pulse is respectively applied, and a third electrode formed between the first electrode and the second electrode. In the method, in a sustain discharge period, a) the third electrode is biased at a first voltage while the sustain discharge voltage pulse is applied to one of the first electrode and the second electrode in a first part of the sustain discharge period, and b) the third electrode is biased at a second voltage which is less than the first voltage while the sustain discharge voltage pulse is alternately applied to the first electrode and the second electrode in a second part of the sustain discharge period.

In one exemplary embodiment of the present invention a method for driving a plasma display is provided. The method includes a first electrode and a second electrode to which a sustain discharge voltage pulse is respectively applied, and a third electrode formed between the first electrode and the second electrode. In the method, a) whether a type of an input image signal is a first type or a second type is determined, b) the third electrode is floated (or biased at first voltage) while the sustain discharge voltage pulse is alternately applied to the first electrode and the second electrode in a first period when the type of the input image determined in a) is the first type, and c) the third electrode is biased at a second voltage while the sustain discharge voltage pulse is alternately applied to the first electrode and the second electrode in the first period when the type of the input image determined in a) is the second type.

In one exemplary embodiment of the present invention, a method for driving a plasma display is provided. The plasma display includes a plurality of alternately arranged first electrodes and second electrodes, and a plurality of third electrodes formed between the first electrodes and the second electrodes. In the method, in a sustain discharge period, a) the first electrode is biased at a first voltage, b) a second voltage which is greater than the first voltage and a third voltage which is less than the first voltage are alternately applied to the second electrode, and c) a fourth voltage which is greater than the first voltage is applied to the third electrode while the second voltage is applied to the second electrode, and a fifth voltage which is not greater than the first voltage is applied to the third electrode while the third voltage is applied to the second electrode.

In one exemplary embodiment of the present invention a plasma display is provided. The plasma display includes: a plasma display panel including an X electrode and a Y electrode to which a sustain discharge voltage pulse is respectively applied, an M electrode formed between the X electrode and the Y electrode, and an address electrode being insulated and crossing the X electrode, the Y electrode, and the M electrode; an address driver for applying a display data signal for selecting a discharge cell to the address electrode; an X electrode driver and a Y electrode driver for respectively applying the sustain discharge voltage pulse for performing a sustain discharge operation to the X electrode and the Y electrode; an M electrode driver for biasing the M electrode at a first voltage in a first part of a sustain discharge period, and for floating the M electrode in a second part of the sustain discharge period; and a controller for supplying a control signal to the address driver, the X electrode driver, the Y electrode driver, and the M electrode driver.

### BRIEF DESCRIPTION OF THE DRAWINGS

The accompanying drawings, together with the specification, illustrate exemplary embodiments of the present invention and together with the description serve to explain the principles of the invention.

FIG. 1 shows a perspective view of a conventional plasma display panel (PDP).

FIG. 2 shows a sectional view of the PDP shown in FIG. 1.

FIG. 3 shows an electrode arrangement of the conventional plasma display.

FIG. 4 shows driving waveforms of the conventional plasma display.

FIG. 5 shows an electrode arrangement of a plasma display according to an exemplary embodiment of the present invention.

FIG. 6 and FIG. 7 respectively show a perspective view and a sectional view of the plasma display according to the exemplary embodiment of the present invention.

FIG. 8 shows driving waveforms of the plasma display according to a first exemplary embodiment of the present invention.

FIG. 9A to FIG. 9E show diagrams for representing wall charge distribution when the waveforms shown in FIG. 8 are applied.

FIG. 10 shows a diagram for representing the plasma display according to an exemplary embodiment of the present invention.

FIG. 11 shows a more detailed diagram for representing driving waveforms shown in FIG. 8.

FIG. 12A and FIG. 12B show driving waveforms of the plasma display according to a second exemplary embodiment of the present invention.

FIG. 13 shows a diagram for representing an equivalent circuit when an M electrode is floated.

FIG. 14A and FIG. 14B show driving waveforms of the plasma display according to a third exemplary embodiment of the present invention.

FIG. 15 shows a diagram for representing a configuration of a controller for supplying driving waveforms according to a fourth exemplary embodiment of the present invention.

FIG. 16 and FIG. 17 show driving waveforms of the PDP according to fifth and sixth exemplary embodiments of the present invention.

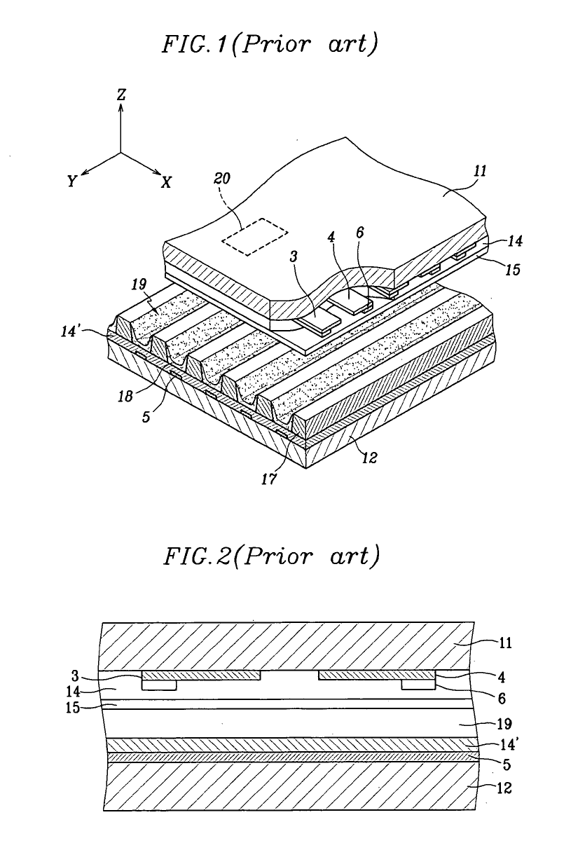

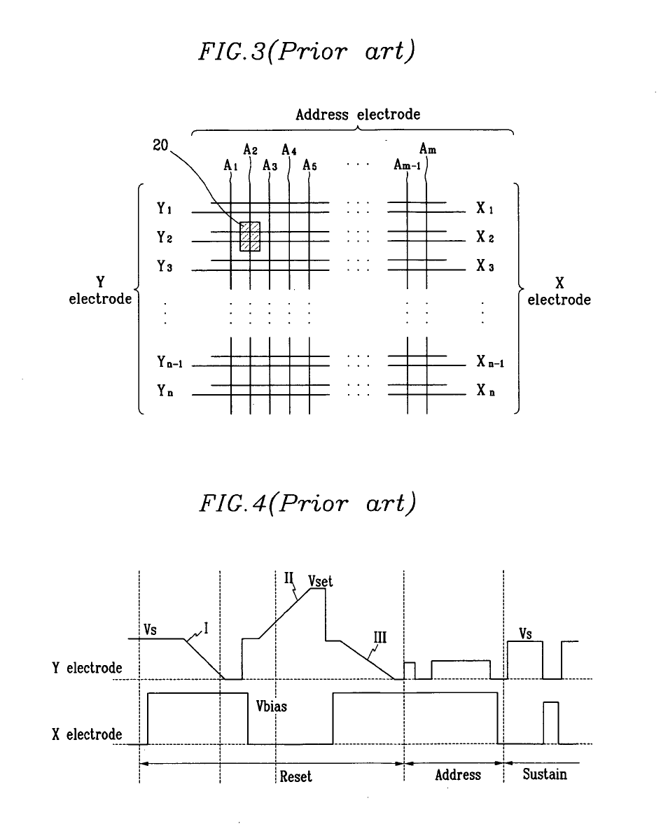

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

There may be parts shown in the drawings, or parts not shown in the drawings, that are not discussed in the specification as they are not essential to a complete understanding of the invention. Like reference numerals designate like elements.

Exemplary embodiments of the present invention will now be described with reference to the drawings.

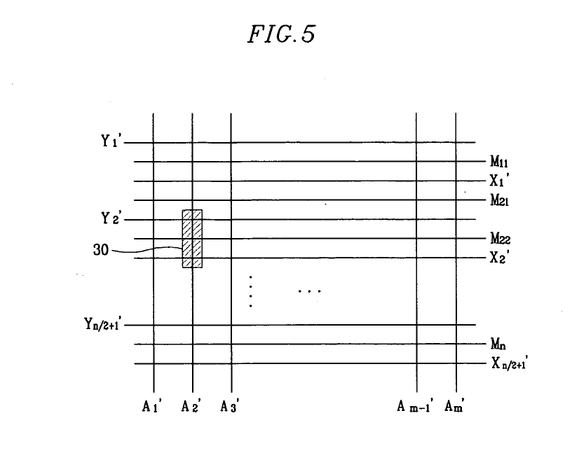

FIG. 5 shows an electrode arrangement of a plasma display according to an exemplary embodiment of the present invention.

As shown in FIG. 5, address electrodes A₁′ to Aₘ′ are arranged in parallel in a column direction, and n/2+1 Y electrodes Y₁′ to Y_{n/2+1}′, n/2+1 X electrodes X₁′ to X_{n/2+}₁′, and n M electrodes (hereinafter, referred to as an M electrode) M₁₁, M₂₁, M₂₂ to Mₙ are arranged in a row direction in the plasma display according to the exemplary embodiment of the present invention. That is, according to the exemplary embodiment of the present invention, the respective M electrodes M₁₁, M₂₁, M₂₂ to Mₙ are arranged between the Y and X electrodes, and the plasma display has a four-electrode configuration in which a Y electrode, an X electrode, an M electrode, and an address electrode form a discharge cell 30.

The X electrode and the Y electrode are mainly used to apply a sustain discharge voltage waveform, and the M electrode is mainly used to apply a reset waveform and a scan pulse voltage.

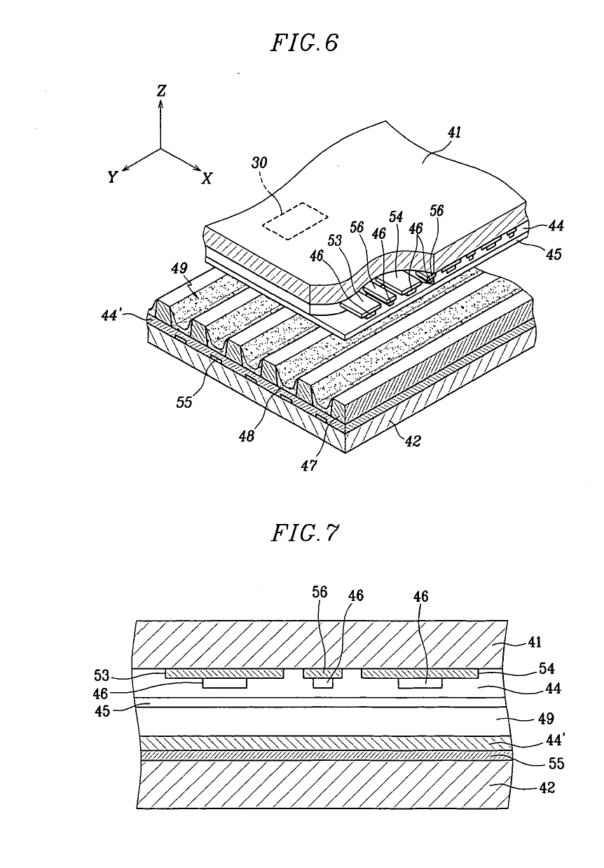

FIG. 6 shows a perspective view of the plasma display according to the exemplary embodiment of the present invention, and FIG. 7 shows a sectional view of the plasma display shown in FIG. 6.

As shown in FIG. 6 and FIG. 7, the plasma display panel according to the exemplary embodiment of the present invention includes a first substrate 41 and a second substrate 42. X electrodes 53 and Y electrodes 54 are formed on the first substrate 41. Bus electrodes 46 are formed on the X electrodes 53 and the Y electrodes 54. A dialectic layer 44 and a protection film 45 are also formed on the X electrodes 53 and the Y electrodes 54 in sequence.

Address electrodes 55 are formed on the second substrate 42, and a dialectic layer 44′ is formed on the address electrodes 55. Barrier ribs 47 are formed on the dialectic layer 44′, and discharge spaces 49 are formed between the barrier ribs 47. Discharge spaces 49 include schematically indicated cell 30 that substantially corresponds to discharge cell 30 shown in FIG. 5. Phosphors 48 are applied on the surface of the barrier ribs 47 in discharge spaces 49 between the barrier ribs 47. The address electrodes 55 are formed crossing the X electrodes 53 and the Y electrodes 54.

In addition, M electrodes 56 are formed between pairs of the X electrodes 53 and the Y electrodes 54 formed on the first substrate 41. As such, a reset waveform and a scan waveform are applied to the M electrodes as described above. Bus electrodes 46 are also formed on the M electrodes 56.

According to the exemplary embodiment of the present invention shown in FIG. 5 to FIG. 7, the plasma display panel has a configuration in which the M electrodes are provided between an Xᵢ electrode and a Yᵢ electrode, and between the Yᵢ electrode and the Xᵢ₊₁ electrode. That is, n M electrodes are provided in the configuration when n/2+1 X electrodes and n/2+1 Y electrodes are provided. However, it may be possible that the M electrodes 56 are provided between the Xᵢ electrode 53 and the Yᵢ electrode 54 and are not provided between the Yᵢ electrode and the Xᵢ₊₁ electrode. In this case, the numbers of X electrodes, Y electrodes, and M electrodes correspond to each other, and the numbers are n.

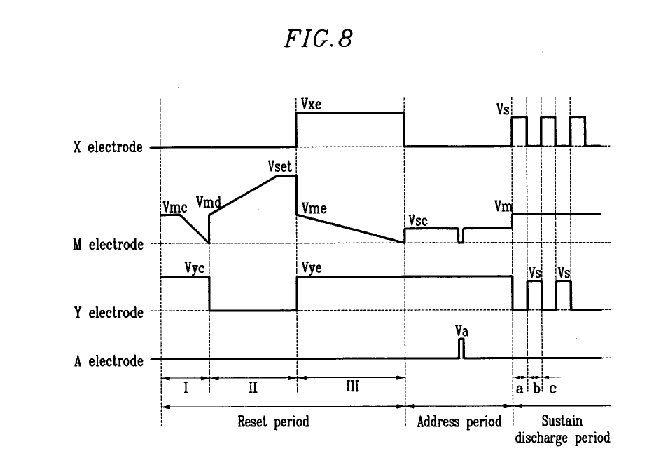

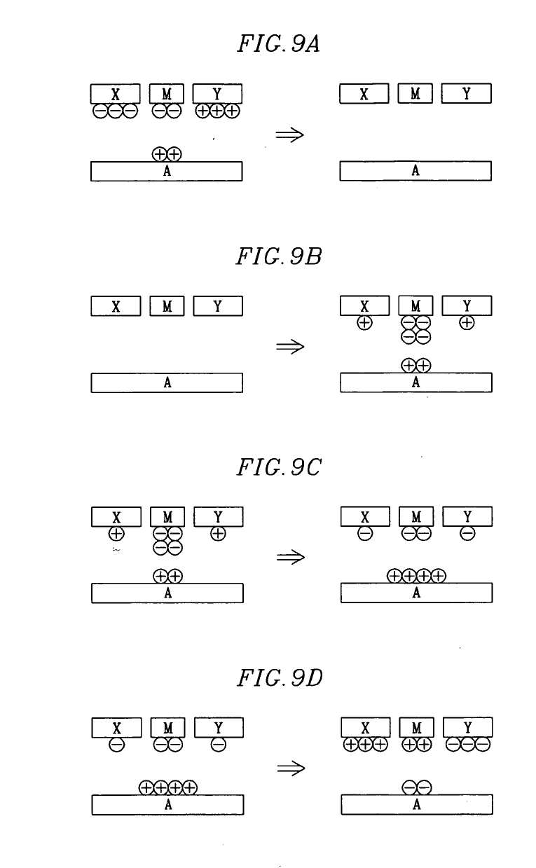

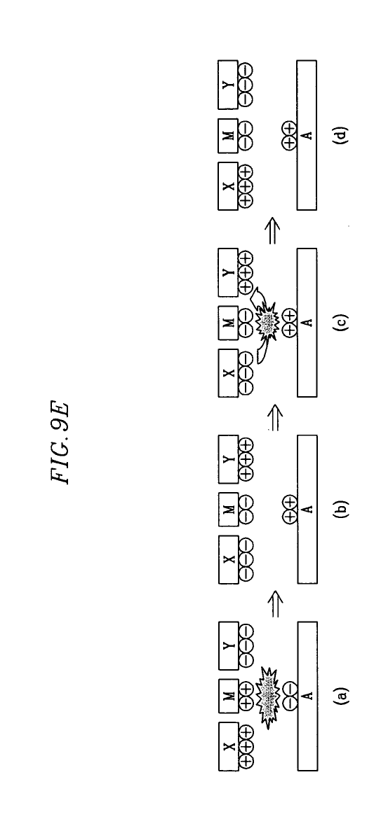

FIG. 8 shows driving waveforms of the plasma display according to a first exemplary embodiment of the present invention, and FIG. 9A to FIG. 9E show diagrams for representing wall charge distribution when the waveforms shown in FIG. 8 are applied.

A driving method of the plasma display according to the first exemplary embodiment of the present invention will now be described with reference to FIG. 8 and FIG. 9A to FIG. 9E.

In the driving method shown in FIG. 8 according to the first exemplary embodiment of the present invention, each subfield has a reset period, an address period, and a sustain period.

According to the first exemplary embodiment of the present invention, the reset period has an erasing period (I), an M electrode rising waveform period (II), and an M electrode falling waveform period (III).

(1-1) Erasing Period (I)

In this period, wall charges formed in a previous sustain discharge period are eliminated. According to the first exemplary embodiment of the present invention, it will be assumed that a sustain discharge voltage pulse at a voltage of Vs is applied to the X electrode in the latter sustain discharge period, and a voltage (e.g. a ground voltage or 0V) which is less than the voltage Vs applied to the X electrode is applied to the Y electrode. As shown in FIG. 9A, (+) wall charges are formed on the Y electrode and the address electrode, and (−) wall charges are formed on the X electrode and the M electrode.

In the erasing period, a waveform (a ramp waveform or a log waveform) gradually falling from a voltage of Vmc to a ground voltage is applied to the M electrode while the Y electrode is biased at a voltage of Vyc. As such, the wall charges formed in the sustain discharge period are eliminated as shown in FIG. 9A.

(1-2) M Electrode Rising Waveform Period (II)

In this period, a waveform (a ramp waveform or a log waveform) gradually rising from a voltage of Vmd to the voltage of Vset is applied to the M electrode while the X electrode and the Y electrode are biased at a ground voltage. Weak reset discharges are generated from the M electrode to the address electrode, the X electrode, and the Y electrode in the discharge cells while the rising waveform is applied. Accordingly, as shown in FIG. 9B, the (−) wall charges are accumulated on the M electrode, and the (+) wall charges are concurrently accumulated on the address electrode, the X electrode, and the Y electrode.

(1-3) M Electrode Falling Waveform Period (III)

A waveform (a ramp waveform or a log waveform) gradually falling from a voltage of Vme to the ground voltage is applied to the M electrode while the X electrode and the Y electrode are respectively biased at a voltage of Vxe and a voltage of Vye in the latter reset period. As such, a circuit configuration of the first exemplary embodiment can be simplified when it is established that Vxe=Vye, Vmd=Vme; however, the first exemplary embodiment is not necessarily restricted to these voltage correspondence(s).

Weak reset discharges are generated in the discharge cells while the ramp voltage is falling. At this time, the wall charges formed by the M electrode rising waveform period are to be gradually reduced in the M electrode waveform falling period, and therefore the longer the falling waveform period is (i.e., the gentler the slope is), the more proper the address discharge is generated because the reduced wall charges can be accurately (or more precisely) controlled.

In addition, the wall charges accumulated on the respective electrodes in the cells are substantially uniformly eliminated when the falling waveform is applied to the M electrode. Accordingly, as shown in FIG. 9C, the (+) wall charges are accumulated on the address electrode, and the (−) wall charges are concurrently accumulated on the X electrode, the Y electrode, and the M electrode.

(2) Address Period (Scan Period)

In the address period, a scan pulse is applied to the M electrode by applying a scan voltage (e.g., a ground voltage) while the M electrodes are biased at a voltage of Vsc , and an address voltage is concurrently applied to a cell to be discharged in the address electrode. At this time, the X electrode is maintained at the ground voltage, and the voltage of Vye is applied to the Y electrode (i.e., a voltage which is greater than the voltage at the X electrode is applied to the Y electrode).

A discharge is generated between the M electrode and the address electrode, the discharge expands to the X electrode and the Y electrode, and therefore the (+) wall charges are accumulated on the X electrode and the M electrode, and the (−) wall charges are accumulated on the Y electrode and the address electrode as shown in FIG. 9D.

(3) Sustain Discharge Period

In the sustain discharge period, a sustain discharge voltage pulse (having a voltage of Vs) is alternately applied to the X electrode and the Y electrode (in a pulse train fashion) while the M electrode is biased at a sustain discharge voltage Vm. As such, a sustain discharge is generated in the discharge cell selected in the address period by applying the sustain discharge voltage and the sustain discharge pulse.

At this time, discharges are generated by different mechanisms in the early sustain discharge period and the peak of the period according to the first exemplary embodiment of the present invention. For convenience of descriptions, a discharge generated in the early sustain discharge period will be referred to as a short-gap discharge, and a discharge generated in the peak of the sustain discharge period (i.e., a period away from the early sustain discharge period or in a normal state) will be referred to as a long-gap discharge.

(3-1) Short-Gap Discharge Period

As shown in parts (a) and (b) of FIG. 9E, a (+) voltage pulse is applied to the X electrode and a (−) voltage pulse is applied to the Y electrode in the early sustain discharge period, and the (+) voltage pulse is also applied to the M electrode (herein, the signals (+) and (−) are relative concepts obtained by comparing a voltage at the X electrode (or Y electrode) to a voltage at the Y electrode (or X electrode), and therefore applying a (+) pulse voltage to the X electrode means that a voltage which is greater than a voltage at the Y electrode is applied to the X electrode and the sign of (−) does not necessarily have to be a negative voltage, i.e., a voltage below 0v, and the sign of (+) does not necessarily have to be a positive voltage). Accordingly, a discharge is generated between the X electrode and the Y electrode, and between the M electrode and the Y electrode, which is different from the conventional discharge generated between the X electrode and the Y electrode. That is, according to the first exemplary embodiment of the present invention, a distance between the M electrode and the Y electrode is closer than a distance between the X electrode and the Y electrode, and therefore an electrical field applied between the M electrode and the Y electrode is greater than an electrical field between the X electrode and the Y electrode. As such, the discharge between the M electrode and the Y electrode performs a more dominant role as compared to the discharge between the X electrode and the Y electrode. In the first exemplary embodiment of the present invention, the discharge between the M electrode and the X electrode functions as a main discharge operation, and because the distance between the M electrode and the X electrode is relatively closer, the discharge is referred to as the short-gap discharge.

According to the first exemplary embodiment of the present invention, the short-gap discharge is generated by applying a relatively high electric field in the early sustain discharge period, and therefore a sufficient discharge operation is performed even if there are not enough priming particles generated in the discharge cell in the case of applying the first (or initial) sustain discharge pulse after the address period.

(3-2) Long-Gap Discharge Period

Since the voltage at the M electrode is biased at a predetermined voltage V_{M} after the first sustain discharge pulse of the sustain discharge is applied, a main discharge operation in this period is the discharge between the X electrode and the Y electrode because the discharge between the M electrode and the X electrode or the M electrode and the Y electrode (i.e. short-gap discharge) contributes less to the discharge operation. Therefore an image input by the number of the discharge pulses alternately applied to the X electrode and the Y electrode is displayed.

That is, as shown in parts (c) and (d) of FIG. 9E, the (−) wall charges are continuously accumulated on the M electrode, and the (−) wall charges and the (+) wall charges are alternately accumulated on the X electrode and the Y electrode in the sustain discharge period in a normal state.

As such, a sufficient discharge operation is performed in a state of less priming particles because the discharge operation is performed by the short-gap discharge between the X electrode and the M electrode (or between the Y electrode and the M electrode) in the early sustain discharge period. A stable discharge operation is performed because the discharge operation is performed by the long-gap discharge between the X electrode and the Y electrode in the normal sustain discharge period.

In addition, circuits for driving the X electrode and the Y electrode may be correspondingly designed because symmetrical voltage waveforms can be applied to the X electrode and the Y electrode according to the first exemplary embodiment of the present invention. Accordingly, a stable discharge operation is performed by reducing the distortion of the pulse waveform applied to the X electrode and the Y electrode in the sustain discharge period because a circuit impedance difference between the X electrode and the Y electrode is eliminated.

According to the first exemplary embodiment of the present invention shown in FIG. 8, the PDP operates (or is driven) when the waveforms of the X electrode and the Y electrode are inverted (or mirrored), and the PDP also operates when the waveforms of the X electrode and the Y electrode are inverted (or mirrored) in the address period.

In addition, the reset waveform and the scan pulse waveform are mainly applied to the M electrode, and the sustain voltage waveform is mainly applied to the X electrode and the Y electrode. At this time, the reset waveform applied to the M electrode can be the reset waveform shown in FIG. 8, as well as various other suitable types of reset waveforms.

In particular, when the various types of reset waveforms are applied in the four electrode configuration according to the first exemplary embodiment of the present invention, required conditions are as follows.

First, in the rising reset waveform period, a voltage waveform Rm(v) applied to the M electrode should be established to be greater than a voltage waveform Rx(v) applied to the X electrode or a voltage waveform Ry(v) applied to the Y electrode (i.e., Rm(v)>(Rx(v) or Ry(v))).

Second, in the falling reset waveform period, a voltage waveform Fm(v) applied to the M electrode should be established to be less than a voltage waveform Fx(v) applied to the X electrode or a voltage waveform Fy(v) applied to the Y electrode (i.e., Fm(v)<(Fx(v) or Fy(v))).

Third, in the address period, a voltage waveform Am(v) applied to the M electrode should be established to be less than a voltage waveform Ax(v) applied to the X electrode or a voltage waveform Ay(v) applied to the Y electrode (i.e., Am(v)<(Ax(v) or Ay(v))).

Fourth, in the sustain discharge period, a voltage waveform Sm(v) applied to the M electrode should be established to be greater than a voltage waveform Sx(v) applied to the X electrode or a voltage waveform Sy(v) applied to the Y electrode (i.e., Sm(v)<(Sx(v) or Sy(v))). Also, the voltage waveform Sm(v) applied to the M electrode in the sustain discharge period should be established to be greater than the voltage waveform Am(v) applied to the M electrode in the address period.

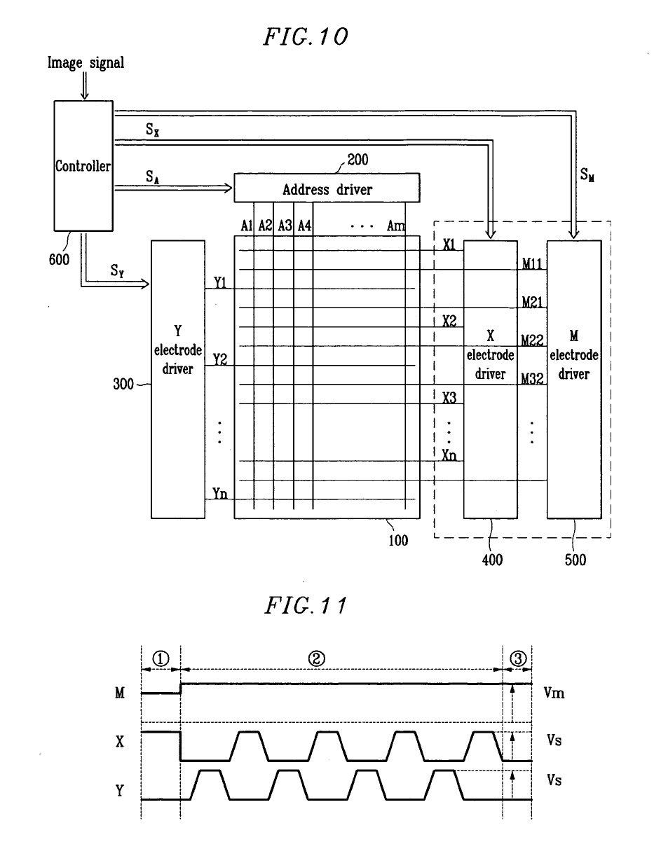

FIG. 10 shows a diagram for representing the plasma display according to an exemplary embodiment of the present invention.

As shown in FIG. 10, the plasma display includes a plasma display panel 100, an address driver 200, a Y electrode driver 300, an X electrode driver 400, an M electrode driver 500, and a controller 600.

The plasma display panel 100 includes a plurality of address electrodes A1 to Am arranged in the column direction, and a plurality of Yi electrodes (e.g., Y1 to Yn), Xj electrodes (e.g., X1 to Xn), and Mij electrodes (e.g., M11, M21, M22, M32, etc.) arranged in the row direction. At this time, the Mij electrodes are provided between the Yi electrode and the Xj electrode.

The address driver 200 receives an address driving control signal S_{A} from the controller 600, and applies a display data signal to each address electrode in order to select a discharge cell to be displayed.

The Y electrode driver 300 receives a Y electrode driving signal S_{Y} from the controller 600, and applies, for example, the waveform shown in FIG. 8 to the Y electrode.

The X electrode driver 400 receives an X electrode driving signal S_{X} from the controller 600, and applies, for example, the waveform shown in FIG. 8 to the X electrode.

The M electrode driver 500 receives an M electrode driving signal S_{M} from the controller 600, and applies, for example, the waveform shown in FIG. 8 to the M electrode.

The controller 600 externally receives an image signal, and generates the address driving control signal S_{A}, the Y electrode driving signal S_{Y}, the X electrode driving signal S_{X}, and the M electrode driving signal S_{M}.

FIG. 11 shows a more detailed diagram for representing driving waveforms shown in FIG. 8. In particular, as can be derived with reference to FIG. 9E, while the bias voltage Vm applied to the M electrode contributes to a discharge firing of the first sustain pulse, the discharge caused by the bias voltage applied to the M electrode should be minimized from the second sustain pulse. That is, a discharge which is not desired may occur between the M electrode and the X electrode or between the M electrode and the Y electrode when the applied voltages at the X electrode and the Y electrode are 0V after a discharge operation or the applied voltages at the X electrode and the Y electrode are increased (or reduced). The discharge occurs by the positive bias voltage applied to the M electrode and the negative wall charges accumulated on the X electrode (or the Y electrode). As such, the wall charges accumulated on the X electrode (or the Y electrode) are eliminated by the discharge, and the next sustain discharges are affected.

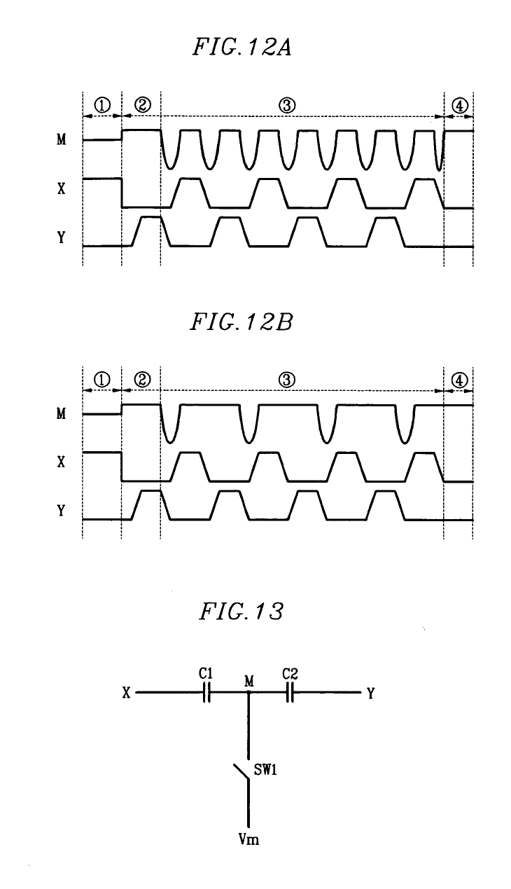

FIG. 12A shows driving waveforms of the plasma display according to a second exemplary embodiment of the present invention.

As shown in FIG. 12A, the M electrode is floated from the second discharge pulse period while the M electrode is biased at a predetermined voltage in the first sustain discharge pulse period according to the second exemplary embodiment of the present invention (e.g., this can be achieved, by biasing the M electrode at the predetermined voltage with an external power supply (not shown) in the first sustain discharge pulse period and then disconnecting the external power supply from the M electrode to leave the M electrode in a floating state in the second discharge period).

FIG. 13 shows a diagram for representing an equivalent circuit when an M electrode is floated.

In FIG. 13, C1 denotes a capacitor between the X electrode and the M electrode, and C2 denotes a capacitor between the Y electrode and the M electrode. At this time, it will be assumed that C1=C2. Accordingly, a voltage of Vmf at the M electrode when the M is floated is given in Equation 1, where Vx denotes a voltage applied to the X electrode, and Vy denotes a voltage applied to the Y electrode.

$$Vmf = \frac{C1Vx + C2Vy}{C1 + C2} = \frac{Vx + Vy}{2} \qquad [ Equation 1 ]$$

In Equation 1, the voltage at the M electrode corresponds to an average voltage of the voltage applied to the X electrode and the voltage applied to the Y electrode. Accordingly, the voltage applied to the M electrode is reduced to less than the bias voltage by floating the M electrode from the second sustain discharge pulse, and therefore no discharge relating to the M electrode is generated when the sustain discharge pulses applied to the X electrode and the Y electrode are increased and reduced according to the second exemplary embodiment of the present invention shown in FIG. 12A.

According to the second exemplary embodiment of the present invention shown in FIG. 12A, a discharge relating to the M electrode is not generated by continuously floating the M electrode from the second sustain discharge pulse when the sustain discharge pulses applied to the X electrode and the Y electrode are increased and reduced. In an alternative second exemplary embodiment, as shown in FIG. 12B, the M electrode can be floated in a falling part or parts of the Y electrode waveform and the M electrode can then be biased in the other parts of the Y electrode waveform. As such, the discharge relating to the M electrode in FIG. 12B is not generated in the falling part of the Y electrode.

While it has been exemplified that the M electrode is floated from the second sustain discharge pulse in the second exemplary embodiment (and the alternative second exemplary embodiment) of the present invention shown in FIG. 12A and FIG. 12B, the M electrode may also be floated from a pulse after the second sustain discharge pulse (e.g. from a third sustain discharge pulse). As such, the present invention is not thereby limited.

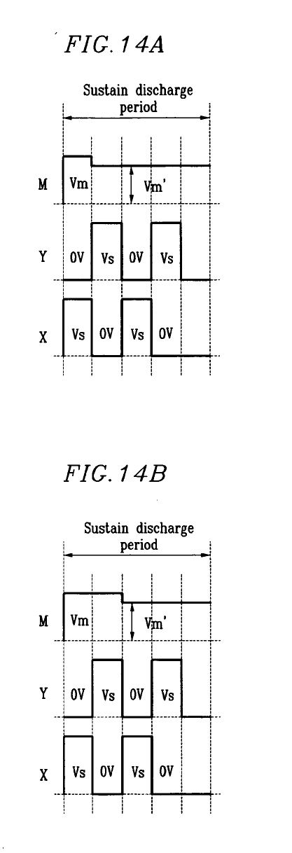

FIG. 14A shows driving waveforms of the plasma display according to a third exemplary embodiment of the present invention.

As shown in FIG. 14A, the M electrode is biased at the sustain discharge voltage Vm in the first sustain discharge pulse period, and therefore the short-gap discharge is performed between the M electrode and the X electrode or the M electrode and the Y electrode according to the third exemplary embodiment of the present invention. A voltage of Vm′, which is less than the sustain discharge voltage Vm, is applied to the M electrode from the second sustain discharge pulse. At this time, the voltage of Vm′ applied to the M electrode from the second sustain discharge pulse is established to be a voltage such that the sustain discharge is not applied between the M electrode and the X electrode or the M electrode and the Y electrode.

According to the third exemplary embodiment of the present invention, the discharge relating to the M electrode is not generated when the sustain discharge pulse applied to the X electrode and the Y electrode is reduced (or increased) or the X electrode and the Y electrode are grounded because the voltage of Vm′ applied to the M electrode from the second sustain discharge pulse is less than the sustain discharge voltage Vm.

According to the third exemplary embodiment of the present invention shown in FIG. 14A, while it has been exemplified that the voltage of Vm′ is applied to the M electrode from the second sustain discharge pulse, the voltage of Vm′ may instead be applied to the M electrode from the third sustain discharge pulse as is shown in FIG. 14B.

Driving waveforms according to a fourth exemplary embodiment of the present invention will now be described.

In the conventional plasma display, a screen load ratio is calculated according to an average signal level of image data, and an automatic power control method is used, in which power consumption is automatically controlled according to the load ratio. In the automatic power control method, the screen ratio is divided into steps (e.g. 256 steps), a number of the sustain discharge pulses is established for each step, the number of the sustain discharge pulses is reduced at a high screen load ratio, the number of the sustain discharge pulses is increased at a low screen load ratio, and therefore the power consumption is reduced.

A high-efficiency plasma display having the four electrode configuration as shown in FIG. 5 and/or FIG. 10 may cause a gray scale expression problem in the high load ratio screen because the sustain discharge pulses, which are used in a high load ratio screen, are reduced to a quarter of the plasma display having the three electrode configuration.

Considering the above problem, the driving waveforms shown in FIG. 11 and FIG. 12A (or FIG. 12B) or FIG. 11 and FIG. 14A (or FIG. 14B) are selectively applied according to the load ratios in driving waveforms according to the fourth exemplary embodiment of the present invention. That is, the M electrode is floated as shown in FIG. 12A (or FIG. 12B) or the bias voltage of Vm′ is applied as shown in FIG. 14A (or FIG. 14B) when the load ratio is great and the bias voltage Vm is applied to the M electrode as shown in FIG. 11 when the load ratio is less.

In more detail, according to the fourth exemplary embodiment of the present invention, the M electrode is floated as shown in FIG. 12A (or FIG. 12B) or the bias voltage of Vm′ is applied as shown in FIG. 14A (or FIG. 14B) when the load ratio is great so that the discharge relating to the M electrode may not occur in the parts that the X electrode or the Y electrode is increased (or reduced). Accordingly, brightness for each unit pulse is reduced. That is, according to the fourth exemplary embodiment of the present invention, the more accurate gray scales are expressed in a high load environment because the brightness for each unit pulse (i.e. unit brightness of the gray scale expression) is reduced when the load ratio is great.

In addition, sufficient sustain discharge pulses are provided by the fourth exemplary embodiment of the present invention when the load ratio is less because the bias voltage Vm is applied to the M electrode so that the proper brightness may be represented.

An exemplary plasma display for supplying the driving waveforms according to the fourth exemplary embodiment of the present invention will now be described. The configuration of the exemplary plasma display for supplying the driving waveforms according to the fourth exemplary embodiment of the present invention sufficiently corresponds to that of the plasma display described in FIG. 10 except for the configuration of the controller 600.

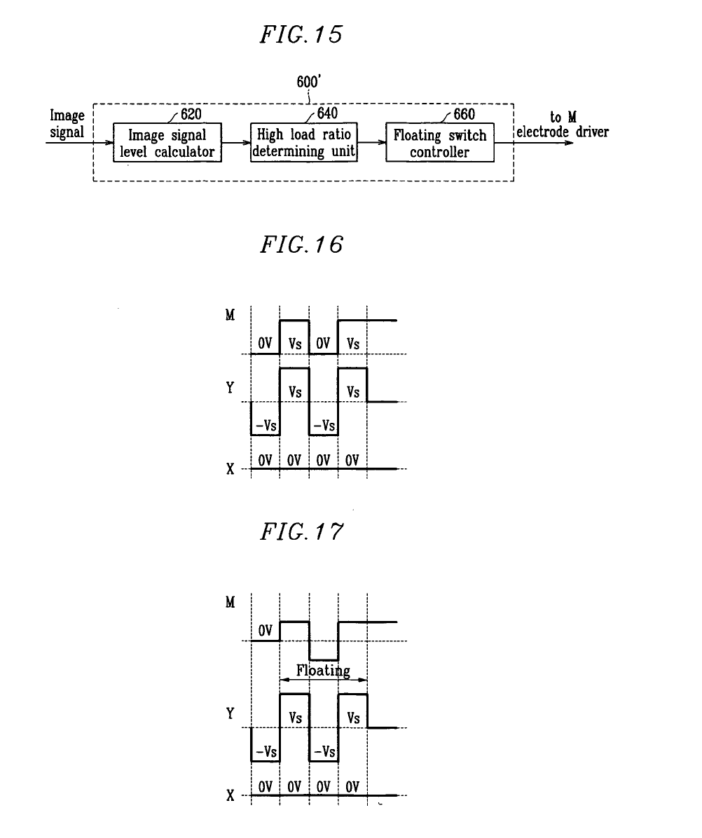

Referring now to FIG. 15, a controller 600′ for supplying driving waveforms according to the fourth exemplary embodiment of the present invention includes an image signal level calculator 620, a high load ratio determining unit 640, and a floating switch controller 660.

The image signal level calculator 620 calculates an average signal level of input image data (red, green, and blue signals) or a plurality of input image signals. At this time, it will be apparent for those skilled in the art to calculate the image signal level, and therefore the description of the calculation will be omitted.

The high load ratio determining unit 640 then determines whether the input image signal is a high load ratio image signal or a low load ratio image signal. At this time, whether or not it is the high load ratio image signal is determined by comparing the input image signal level to a reference signal level (the reference signal level is randomly established).

The floating switch controller 660 then outputs a control signal for turning off a floating switch (not illustrated) coupled between the M electrode and a bias voltage to the M electrode when the input image signal is at the high load ratio, and outputs a control signal for turning on the floating switch to the M electrode when the image signal is at the low load ratio according to the determination of the high load ratio determining unit 640. Alternatively, rather than using the floating switch controller 660, another exemplary embodiment of the present invention may be configured using a second voltage biasing controller (not shown). In this alternative exemplary embodiment, the M electrode is to be biased at a second lower voltage (e.g., Vm′) when the input image is at the high load ratio and to be biased at a first higher voltage (e.g., Vm) when the input image is at the low load ratio.

Driving methods according to fifth and sixth exemplary embodiments of the present invention will now be described with reference to FIG. 16 and FIG. 17.

As shown in FIG. 16, the ground voltage and the voltage of Vs are alternately applied to the M electrode while the X electrode is biased at the ground voltage (or 0V). A voltage of −Vs is applied to the Y electrode while the ground voltage (or 0V) is applied to the M electrode, and the voltage of Vs is applied to the Y electrode while the voltage of Vs is applied to the M electrode.

A voltage between the X electrode and the Y electrode, a voltage between the X electrode and the M electrode, and a voltage between the Y electrode and the M electrode substantially correspond to the waveform shown in FIG. 8 when waveforms shown in FIG. 16 are applied to the X electrode, Y electrode, and M electrode. That is, a sustain discharge operation corresponding to the waveforms shown in FIG. 8 is performed when the waveforms shown in FIG. 16 are applied.

An additional circuit for driving the X electrode is not required because the X electrode is biased at the ground voltage when the driving waveforms shown in FIG. 16 are applied.

With reference to FIG. 17, waveforms of the Y electrode and the X electrode of the sixth exemplary embodiments of the present invention substantially correspond to the waveforms shown in FIG. 16 except that the M electrode is floated in the sustain discharge period.

The waveforms shown in FIG. 17 are provided because the M electrode is maintained at an average voltage value of the X electrode and the Y electrode when the M electrode is floated.

The voltage between the X electrode and the Y electrode, the voltage between the X electrode and the M electrode, and the voltage between the Y electrode and the M electrode substantially correspond to waveforms shown in FIG. 8 when the waveforms shown in FIG. 17 are applied to the X electrode, the Y electrode, and the M electrode.

Accordingly, a circuit configuration of the M electrode driver will be simplified because no additional circuit for driving the X electrode is required and the voltage at the M electrode is floated in the sustain discharge period when the waveforms shown in FIG. 17 are applied.

In general and in view of the forgoing, erroneous discharges in certain exemplary embodiments of the present invention will be prevented because the reset and the first sustain discharges are performed by using the M electrode.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

1. A method for driving a plasma display, the plasma display including a first electrode and a second electrode to which a sustain discharge voltage pulse is respectively applied, and a third electrode formed between the first electrode and the second electrode, the method comprising:
in a sustain discharge period,
a) biasing the third electrode at a first voltage while applying the sustain discharge voltage pulse to the first electrode or the second electrode in a first part of the sustain discharge period; and
b) floating the third electrode while applying the sustain discharge voltage pulse to the first electrode and/or the second electrode in a second part of the sustain discharge period.

2. The method of claim 1, wherein, in b), the sustain discharge voltage pulse is alternately applied to the first electrode and the second electrode when the third electrode is floated.

3. The method of claim 1, wherein the first part of the sustain discharge period comprises a period in which the first sustain discharge is generated.

4. The method of claim 3, wherein the second part of the sustain discharge period is a period after the first sustain discharge.

5. A method for driving a plasma display, the plasma display including a first electrode and a second electrode to which a sustain discharge voltage pulse is respectively applied, and a third electrode formed between the first electrode and the second electrode, the method comprising:
in a sustain discharge period,
a) biasing the third electrode at a first voltage while applying the sustain discharge voltage pulse to one of the first electrode and the second electrode in a first part of the sustain discharge period; and
b) biasing the third electrode at a second voltage which is less than the first voltage while alternately applying the sustain discharge voltage pulse to the first electrode and the second electrode in a second part of the sustain discharge period.

6. The method of claim 5, wherein the first part of the sustain discharge period comprises a period in which the first sustain discharge is generated.

7. The method of claim 6, wherein the second part of the sustain discharge period is a period after the first sustain discharge.

8. A method for driving a plasma display, the plasma display including a first electrode and a second electrode to which a sustain discharge voltage pulse is respectively applied, and a third electrode formed between the first electrode and the second electrode, the method comprising:
a) determining whether a type of an input image signal is a first type or a second type;
b) floating the third electrode or biasing the third electrode at a first voltage while alternately applying the sustain discharge voltage pulse to the first electrode and the second electrode in a first period when the type of the input image signal determined in a) is the first type;
c) biasing the third electrode at a second voltage while alternately applying the sustain discharge voltage pulse to the first electrode and the second electrode in the first period when the type of the input image signal determined in a) is the second type.

9. The method of claim 8, further comprising,
in b) and c),
biasing the third electrode at the second voltage while applying the sustain discharge voltage pulse to one of the first electrode and the second electrode in a second period which is prior to the first period.

10. The method of claim 9, wherein the second period comprises a period in which the first sustain discharge is generated.

11. The method of claim 8, further comprising in a), determining whether a load ratio of the input image signal is a high load ratio or a low load ratio,
wherein the first type comprises the high load ratio and the second type comprises the low load ratio.

12. The method of claim 11, further comprising,
in a), calculating an average signal level of input image signals; and
comparing the calculated average signal level to a reference signal level to determine whether the load ratio of the input image signal is the high load ratio or the low load ratio.

13. The method of claim 8, wherein the third electrode is floated and not biased at the first voltage while alternately applying the sustain discharge voltage pulse to the first electrode and the second electrode in the first period when the type of the input image signal determined in a) is the first type.

14. The method of claim 8, wherein the third electrode is biased at the first voltage and not floated while alternately applying the sustain discharge voltage pulse to the first electrode and the second electrode in the first period when the type of the input image signal determined in a) is the first type and wherein the first voltage is less than the second voltage.

15. A method for driving a plasma display, the plasma display including a plurality of first electrodes and second electrodes alternately arranged, and a plurality of third electrodes formed between the first electrodes and the second electrodes, the method comprising:
in a sustain discharge period,
a) biasing at least one of the first electrodes at a first voltage;
b) alternately applying a second voltage which is greater than the first voltage, and a third voltage which is less than the first voltage to at least one of the second electrodes; and
c) applying a fourth voltage which is greater than the first voltage to at least one of the third electrodes while the second voltage is applied to the at least one second electrode, and applying a fifth voltage which is not greater than the first voltage to the at least one third electrode while the third voltage is applied to the at least one second electrode.

16. The method of claim 15, wherein the first voltage is a ground voltage.

17. The method of claim 16, Wherein a level of the second voltage substantially corresponds to a level of the third voltage and the polarity of the second voltage is opposite to that of the third voltage.

18. The method of claim 16, wherein a level of the second voltage substantially corresponds to a level of the fourth voltage and wherein a level of the third voltage substantially corresponds to a level of the fifth voltage.

19. The method of claim 15, wherein the fourth voltage and the fifth voltage are applied to the at least one third electrode by floating the at least one third electrode.

20. The method of claim 15, wherein the fifth voltage is less than the first voltage.

21. A plasma display comprising:
a plasma display panel including an X electrode and a Y electrode to which a sustain discharge voltage pulse is respectively applied, an M electrode formed between the X electrode and the Y electrode, and an address electrode being insulated and crossing the X electrode, the Y electrode, and the M electrode;
an address driver for applying a display data signal for selecting a discharge cell to the address electrode;
an X electrode driver and a Y electrode driver for respectively applying the sustain discharge voltage pulse for performing a sustain discharge operation to the X electrode and the Y electrode;
an M electrode driver for biasing the M electrode at a first voltage in a first part of a sustain discharge period, and for floating the M electrode in a second part of the sustain discharge period; and
a controller for supplying a control signal to the address driver, the X electrode driver, the Y electrode driver, and the M driver.

22. The plasma display of claim 21, wherein the M electrode driver floats the M electrode in the second part of the sustain discharge period when a load ratio of an input image signal is a high load ratio, and biases the M electrode at the first voltage when the load ratio of the input image signal is a low load ratio.

23. The plasma display of claim 22, wherein the controller comprises:
an image signal level calculator for calculating an average signal level of a plurality of input image signals;
a high load ratio determining unit for determining whether the load ratio of the input image signal is the high load ratio or the low load ratio based on the average signal level of the plurality of input image signals calculated by the image signal level calculator; and
a controller for outputting a first control signal for turning off a floating switch coupled between the M electrode and the first voltage to the M electrode driver when the load ratio of the input image signal is the high load ratio according to results determined by the high load ratio determining unit, and for outputting a second control signal for turning on the floating switch to the M electrode driver when the load ratio of the input image signal is the low load ratio.
